(19) United States
(12) Patent Application Publication
(10) Pub. No.: US 2002/0185826 A1
(43) Pub. Date: Dec. 12, 2002

(54) Dual-shaft link direction control structure of light bicycle

(76) Inventors: Tseng-Hsien Chen, I Lan Hsien (TW); Tsuan Hung Chen, I Lan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/877,048

(22) Filed: Jun. 11, 2001

(51) Int. Cl. B60R 1/00

(52) U.S. Cl. 280/1

(57) ABSTRACT

A dual-shaft link direction control structure of a light bicycle comprises a fixing rod, an upper turntable, a lower turntable, two auxiliary rods, and a link. The rear end of the fixing rod is connected with the front-end portion of a frame of a light bicycle, and the front end thereof is inserted by a control handle pivotally connected with the upper and lower turntables. The upper and lower turntables are pivotally connected with the two auxiliary rods. One end of the auxiliary rods is pivotally connected with one end of the link. The other end of the link is pivotally connected with a front fork portion of the light bicycle. The upper and lower turntables, the two auxiliary rods, and the link can facilitate direction control and ride of the light bicycle. Moreover, the volume of the light bicycle can be shrunk, hence achieving convenience in use and storage.

### FIELD OF THE INVENTION

The present invention relates to a dual-shaft link direction control structure of a light bicycle and, more particularly, to a novel direction control structure getting rid of the restriction of design of a conventional light bicycle body and capable of maintaining appropriate distances conforming to human engineering.

### BACKGROUND OF THE INVENTION

FIG. 1 shows the structure of a light bicycle invented in 1870. The light bicycle 10 comprises a control handle 101, a cushion 102, a frame 103, a large wheel 104, two pedals 105, and a small wheel 106. However, in the above light bicycle 10, because the distance between the cushion 102 and the control handle 101 is too short, and the distance between the control handle 101 and the large wheel 104 is also too short, turnabout of the control handle 101 is difficult, resulting in inconvenience ride and less comfort. In other words, the light bicycle 10 evidently did not conform to human engineering. Therefore, the light bicycle 10 has been eliminated through competition shortly after presented to the public. Accordingly, the prior art light bicycle has inconvenience and drawbacks in practical use. The present invention aims to resolve the above problems.

### SUMMARY OF THE INVENTION

The primary object of the present invention is to provide a dual-shaft link direction control structure of a light bicycle to get rid of the technical bottleneck of not easily controlling the balance of a light bicycle body through a control handle and the restriction of design of a conventional light bicycle body, thereby not only maintaining appropriate distances conforming to human engineering, but also obtaining better comfort for a user riding the light bicycle. Moreover, the whole volume of the light bicycle can be shrunk, achieving much convenience in use and storage for the user.

To achieve the above object, the present invention provides a dual-shaft link direction control structure of a light bicycle. The direction control structure comprises a fixing rod, an upper turntable, a lower turntable, two auxiliary rods, and a link. The front and rear ends of the fixing rod are hollow. The rear end of the fixing rod is inserted by a fixing part to connect the front-end portion of a light bicycle. The front end of the fixing rod is connected with a control handle to facilitate the control of direction. The control handle is also pivotally connected with the upper turntable, the lower turntable, the two auxiliary rods, and one end of the link. The other end of the link is pivotally connected with a front fork portion of the light bicycle. When the control handle is turned, the upper turntable, the lower turntable, the two auxiliary rods, and the link are led to turn, thereby driving a large wheel of the light bicycle to turn according to the direction turned by the rider.

The various objects and advantages of the present invention will be more readily understood from the following detailed description when read in conjunction with the appended drawing, in which:

### BRIEF DESCRIPTION OF THE DRAWINGS

FIG. 1 is a plan diagram of a prior art bicycle;

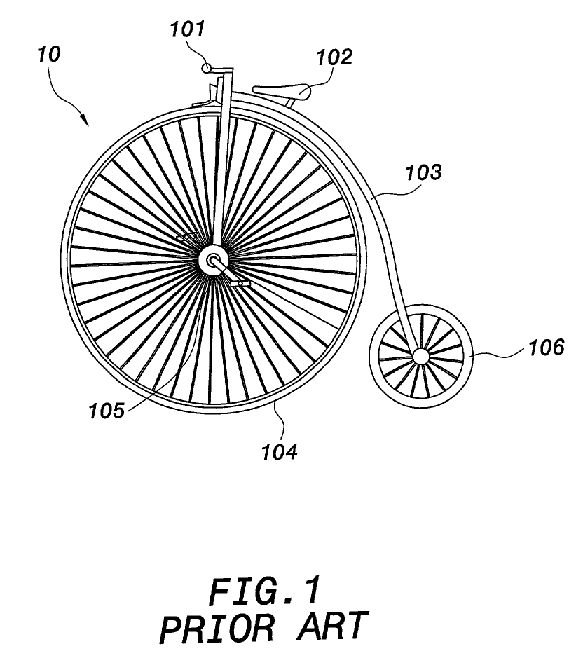

FIG. 2 is a perspective view of the present invention assembled with a light bicycle;

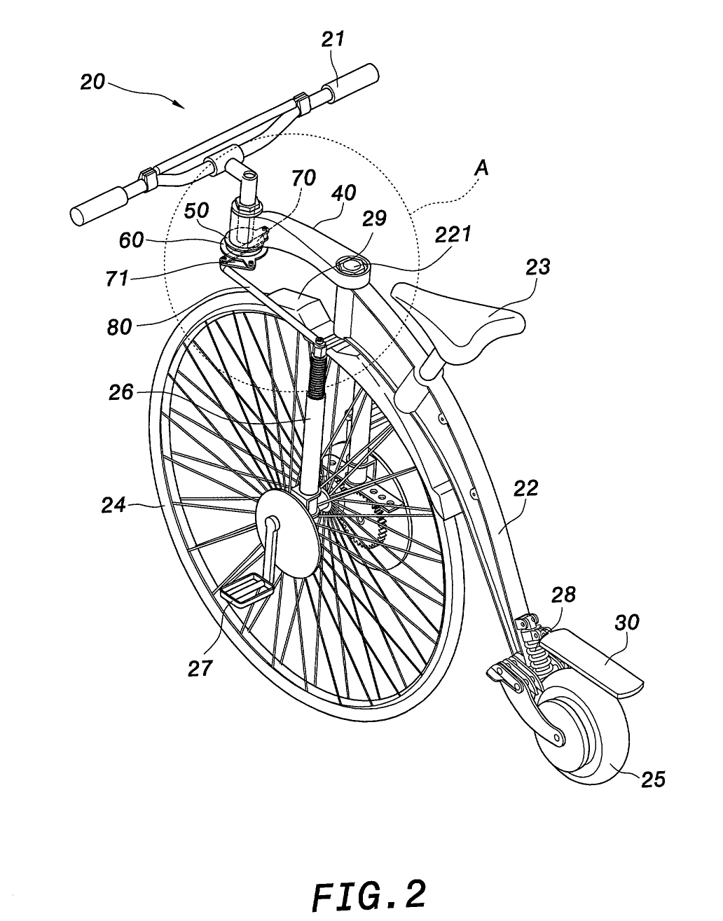

FIG. 3 is an enlarged diagram of the present invention;

FIG. 4 is a cross-sectional view of the present invention;

FIG. 5 is a top view of the present invention;

FIG. 6 is an action diagram of the present invention; and

FIG. 7 is another action diagram of the present invention.

### DETAILED DESCRIPTION OF THE PREFERRED EMBODIMENTS

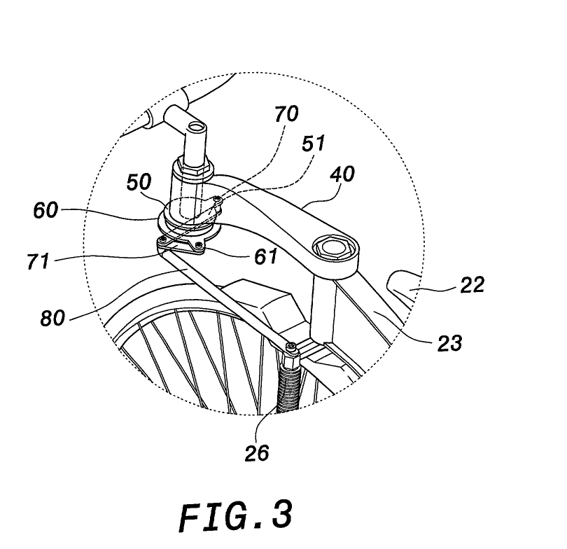

As shown in FIG. 3, the present invention is related to a dual-shaft link direction control structure of a light bicycle. The present invention comprises a light bicycle 20. A control handle 21 is disposed on the light bicycle 20 to control the direction. The control handle 21 is inserted into a fixing rod 40, and is connected with a frame 22 of the light bicycle 20. The frame 22 connects a cushion 23, a large wheel 24, a small wheel 25, a front fork portion 26, two pedals 27, an absorber 28, a front mudguard 29, and a rear mudguard 30.

The cushion 23 is used to provide comfort for a rider. When the rider rides the light bicycle 20, he uses the control handle 21 of the frame 22 to control the direction, and steps on the two pedals 27 to drive the large wheel 24. When the large wheel 24 turns forwards, it also leads the small wheel to turn, letting the light bicycle 20 move forwards. The absorber 28 is used to reduce discomfort due to jolts for the rider. The front mudguard 29 and the rear mudguard 30 are used to block the splashing water and mud. The above structures and connection relationship are the same as the prior art and thus will not be further described.

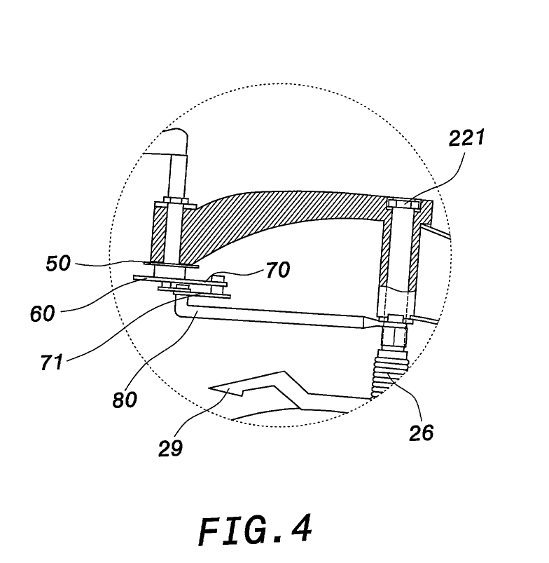

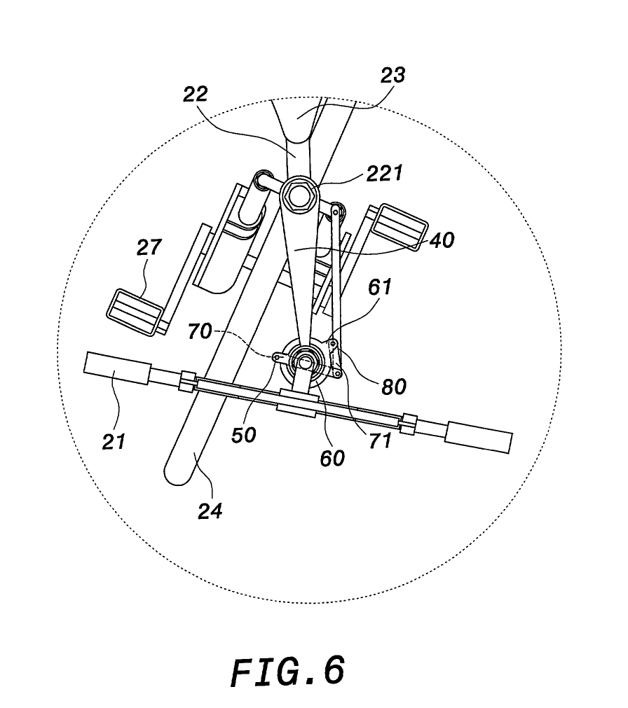

Please refer to FIGS. 3 to 8. The present invention further comprises a fixing rod 40, an upper turntable 50, a lower turntable 60, two auxiliary rods 70 and 71, and a link 80, as shown in FIG. 4.

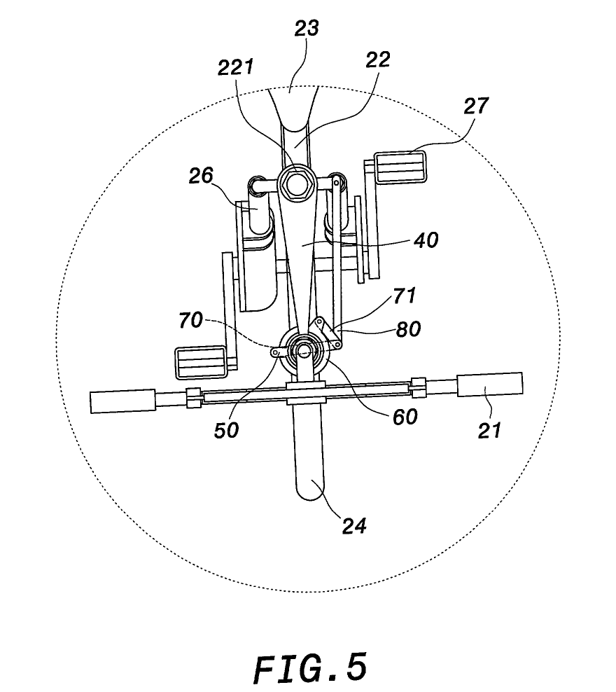

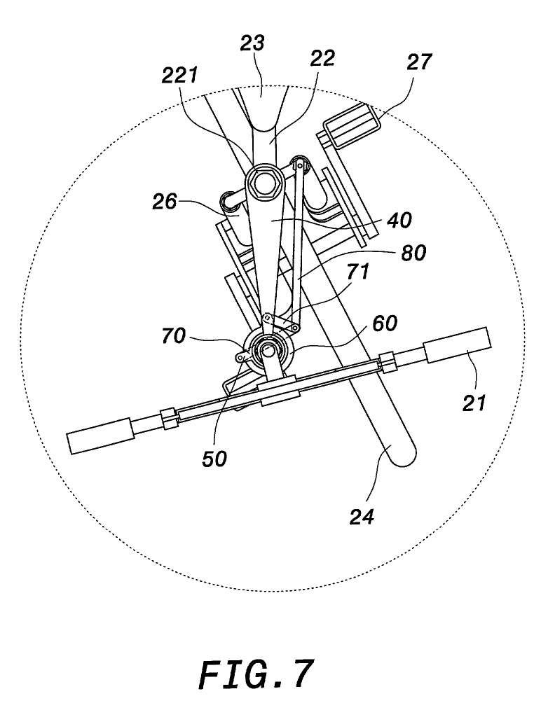

The front and rear ends of the fixing rod 40 are hollow. The rear end of the fixing rod 40 is inserted by a fixing part 221, as shown in FIG. 5. The fixing part 221 can be a screw or a-pin to facilitate the connection and separation of the light bicycle 20 with the fixing rod 40. The fixing part 221 can also connect the rear end of the fixing rod 40 at the front-end portion of the frame 22 of the light bicycle 20, as shown in FIG. 3. The front end of the fixing rod 40 is inserted by the control handle 21 of the light bicycle 20. The control handle 21 can turn in the front end of the fixing rod 40, as shown in FIGS. 7 and 8, so that a rider can use the control handle 21 of the frame 22 to control the direction when riding the light bicycle 20.

The fixing rod 40 can extend the distance between the cushion 23 and the control handle 21, as shown in FIG. 3, and maintain appropriate maneuvering distances of the body and hands of a rider when he rides the light bicycle 20, thereby obtaining better comfort and conforming to human engineering.

The control handle 21 is roughly T-shaped, and protrudes out of the bottom of one end of the fixing rod 40. The control handle 21 is also connected with the upper turntable 50, as shown in FIG. 5. A first flange portion 51 extends from the upper turntable 50, as shown in FIG. 4. The first flange portion 51 is pivotally connected with one end of the first auxiliary rod 70. The other end of the first auxiliary rod 70 is pivotally connected with one end of the link 80.

When the control handle 21 turns, the upper turntable 50 is led to turn. The lower portion of the upper turntable 50 is connected with the lower turntable 60. A second flange portion 61 extends from the lower turntable 61, as shown in FIG. 4. The second flange portion 61 is connected with one end of the second auxiliary rod 71. The other end of the second auxiliary rod 71 is connected with one end of the link 80 along with the first auxiliary rod 70.

One end of the link 80 is pivotally connected with the first auxiliary rod 70 and the second auxiliary rod 71. The other end of the link 80 is pivotally connected with the front fork portion 26 of the light bicycle 20.

The present invention utilizes the fixing rod 40 to extend the distance between the cushion 23 and the control handle 21, thereby maintaining appropriate maneuvering distances of the body and hands for a user riding the light bicycle 20. Moreover, better comfort can be obtained, and the object of conforming to human engineering can be achieved.

Furthermore, when the control handle 21 is turned, the upper turntable 50 will be led to turn, and the lower turntable 60 connected below the upper turntable 50 will also be led to turn. Because the first auxiliary rod 70 and the second auxiliary rod 71 are pivotally connected with one end of the link 80, the front fork portion 26 pivotally joined at the other end of the link 80 will also be led to turn, thereby driving the large wheel 24 to turn to the direction of the control handle 21 turned by a rider.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A dual-shaft link direction control structure of a light bicycle comprising a control handle, said control handle being inserted by a fixing rod, the rear end of said fixing rod being connected with the front end of a frame of said light bicycle, the bottom of said control handle being pivotally connected with an upper turntable and a lower turntable, said two turntables is pivotally connected with a link;
whereby when said control handle is turned to lead said upper turntable, said lower turntable, and said link to turn simultaneously, said light bicycle will turn to the direction controlled by a rider.

2. The dual-shaft link direction control structure of a light bicycle as claimed in claim 1, wherein the rear end of said fixing rod and the front end of said frame of said light bicycle can be joined through a screw or a pin, hence facilitating the connection and separation of said light bicycle with said fixing rod.

3. The dual-shaft link direction control structure of a light bicycle as claimed in claim 1, wherein said fixing rod can be used to extend the distance between said light bicycle and said control handle to conform to human engineering.

4. The dual-shaft link direction control structure of a light bicycle as claimed in claim 1, wherein a flange portion can extend from said upper turntable, said flange portion being pivotally connected with one end of said link to facilitate the control of direction of said light bicycle after being pivotally connected with auxiliary rods.

5. The dual-shaft link direction control structure of a light bicycle as claimed in claim 1, wherein a flange portion can extend from said lower turntable, said flange portion being pivotally connected with one end of said link to facilitate the turn of said light bicycle after being pivotally connected with auxiliary rods.
